(19) United States
(12) Patent Application Publication
(10) Pub. No.: US 2006/0239132 A1
(43) Pub. Date: Oct. 26, 2006

(54) Content identifiers for multilayered optical storage disks

(76) Inventors: Bart Van Rompaey, Eindhoven (NL); Maarten Kuijper, Eindhoven (NL); Josephus Bernardus Maria Segers, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/566,509

(22) PCT Filed: Jul. 26, 2004
(86) PCT No.: PCT/IB04/51287

§ 371 Date: Jan. 30, 2006

(30) Foreign Application Priority Data
Jul. 30, 2003 (EP) 03102359.1

(51) Int. Cl. G11B 21/08

(52) U.S. Cl. 369/30.09

(57) ABSTRACT

The present invention is directed towards a method and device for providing data in a layered storage medium, such a storage medium, a signal (19) for provision of layer data in a storage medium as well as to a method and device for indicating correctness of content data on such a layered storage medium. Each layer of the storage medium comprises at least parts of a set of content data and identifying data (26, 28), which identifying data comprises a content identifier (26) that is common for and indicative of the whole set of content data, such that each layer having data belonging to the same set of content data has the same content identifier. In this way wrong combinations of sets of content data can easily be detected.

The present invention relates to the field of storage mediums and more specifically towards a method for providing data in a layered storage medium, a device for providing a layered storage medium having content data, a layered storage medium, a signal for provision of content data in a layered storage medium as well as a method and device for indicating correctness of data stored in a layered storage medium.

Within the field of storage mediums, such as optical discs, there has lately been a trend towards providing several layers where information can be stored for enhancing the storage capacity. In normal CD discs there is just one layer, but with the introduction of various other formats, like DVD and SACD (Super Audio CD) there has been a provision of two layers than can contain optical information. Lately there has evolved a further standard called BD (Blu-ray Disc), where even more layers are possible in the future.

When producing these type of storage mediums there is a risk that the information content placed in one layer will be combined with the wrong information content that is provided in another layer. For instance, if the two layers are to include data concerning one movie, there might be a risk that content relating to one movie might be placed in one layer and content related to another movie erroneously be placed in another layer. As far as is known, today the only way to find out such a mistake or error is to replay a recorded disc and find these types of errors that way. This is time consuming and therefore not a good way to test manufactured storage mediums in a highly industrialized production process.

There is therefore a need for enabling easier detection of correctness of the data content in different layers of a layered storage medium, so that such errors can be recognized faster and more easily.

U.S. Pat. No. 6,421,315 describes a multilayer optical disc having a plurality of layers. In the different layers there are provided identifiers, which identify layers and tracks in these layers. There is however no information regarding the content in the different layers, hence this document is not suitable for use in identifying correctness according to the principles mentioned above.

It is thus an object of the invention to enable easier detection of correctness of content data in different layers of a layered storage medium, so that combinations of layers with wrong content data can be recognized faster and more easily.

According to a first aspect of the present invention, this object is achieved by a method for providing data in a layered storage medium comprising the steps of:
providing at least one set of content data for storage in at least one layer of the storage medium,
providing, for each layer, identifying data corresponding to a set of content data, of which at least parts is to be provided in the layer, which identifying data comprises a content identifier that is common for and indicative of the whole set of content data, and
storing content data together with corresponding identifying data in each layer of the storage medium, such that each layer having data belonging to the same set has the same content identifier.

According to a second aspect of the present invention, this object is furthermore achieved by a device for providing a layered storage medium having content data, comprising:
at least one layer data transferring unit for providing layer data in different layers of a storage medium, where the data for each layer comprises at least parts of a set of content data and identifying data, which identifying data comprises a content identifier that is common for and indicative of that whole set of content data, and
a combining unit for combining the layers into a layered storage medium, such that each layer having data belonging to the same set of content data has the same content identifier.

According to a third aspect of the present invention, this object is also achieved by a storage medium comprising at least two different layers of layer data, where each layer comprises at least parts of a set of content data and identifying data, which identifying data comprises a content identifier that is common for and indicative of that whole set of content data, such that each layer having data belonging to the same set of content data has the same content identifier.

According to a fourth aspect of the present invention, this object is achieved by a signal for provision of layer data in a layer of a layered storage medium comprising at least parts of a set of content data and identifying data, which identifying data comprises a content identifier that is common for and indicative of that whole set of content data, such that each layer having data belonging to the same set of content data receives the same content identifier.

According to a fifth aspect of the present invention, this object is also achieved by a method of indicating correctness of content data stored in or associated with at least two different layers of a storage medium comprising the steps of:
reading identifying data from or for at least one layer, which identifying data includes a content identifier that is common for and indicative of the whole content of one set of content data, where at least parts of the set is provided in the layer, such that each layer having data belonging to the same set of content data has the same content identifier,
comparing content identifiers, and
indicating if content identifiers in or for investigated layers correspond to a correct combination or not.

According to a sixth aspect of the present invention, this object is furthermore achieved by a device for indicating correctness of data in or for a layered storage medium having at least two layers, where at least one set of content data of a common origin is stored, and comprising:
at least one data reading unit arranged to read identifying data from or for at least one layer, which comprises a content identifier that is common for and indicative of the whole content of one set of content data, where at least parts of the set is provided in the layer, such that each layer having data belonging to the same set of content data has the same content identifier, and
an evaluating unit arranged to compare content identifiers, and
indicate if content identifiers in or for the investigated layers correspond to a correct combination or not.

Claims 2 and 13 are directed towards providing layer identifiers in each layer. This enables assessing the correct sequence of layers in a layered storage medium in a quick and direct manner.

According to claim 3 a set of content data can occupy at least two layers.

Claim 4 is directed towards providing the identifying data in a specific position of the layers for easier reading of the identifying data.

Claims 5 and 6 are directed towards providing the identifying data in specific fields used in different storage formats.

Claims 7 and 8 are directed towards specific forms of the content and layer identifiers.

With the present invention a faster and simpler detection of wrong layer content can be indicated.

The general idea behind the invention is thus to provide, for each layer of a layered storage medium, identifying data corresponding to a set of content data, of which at least parts is to be provided in that layer, which identifying data comprises a content identifier that is common for and indicative of the whole set of content data. Each layer that has content data belonging to the same set therefore has the same content identifier.

The expression set of data is intended to include all types of different data that can be packaged, marketed and sold as one entity. Such a set can include different types of content data such as video streams, sound streams, still images and text in any combination and in any amount of numbers. More than one such set can furthermore be provided on the same layered storage medium.

These and other aspects of the invention will be apparent from the embodiments described hereinafter.

The present invention will also be more clearly understood from the following description of the preferred embodiments of the invention read in conjunction with the attached drawings, in which:

FIG. 1 schematically illustrates a set up for providing a master disc according to the invention,

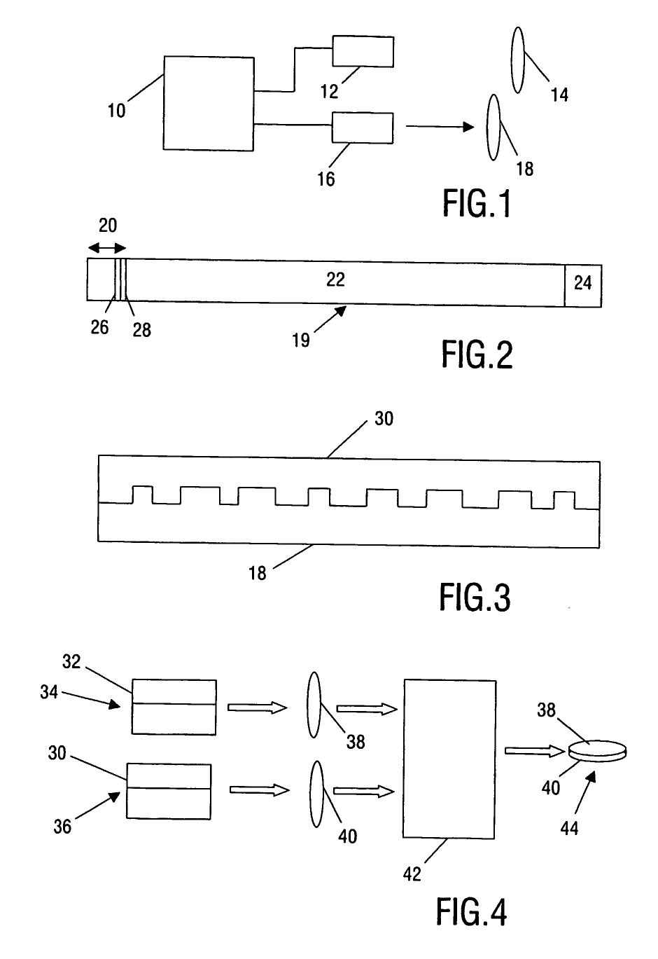

FIG. 2 shows a signal format for use on a layered disc according to one embodiment of the present invention,

FIG. 3 schematically illustrates the forming of a stamper for providing a layer for a layered storage medium according to the invention,

FIG. 4 schematically illustrates a device for forming of the layered storage medium according to one embodiment of the present invention,

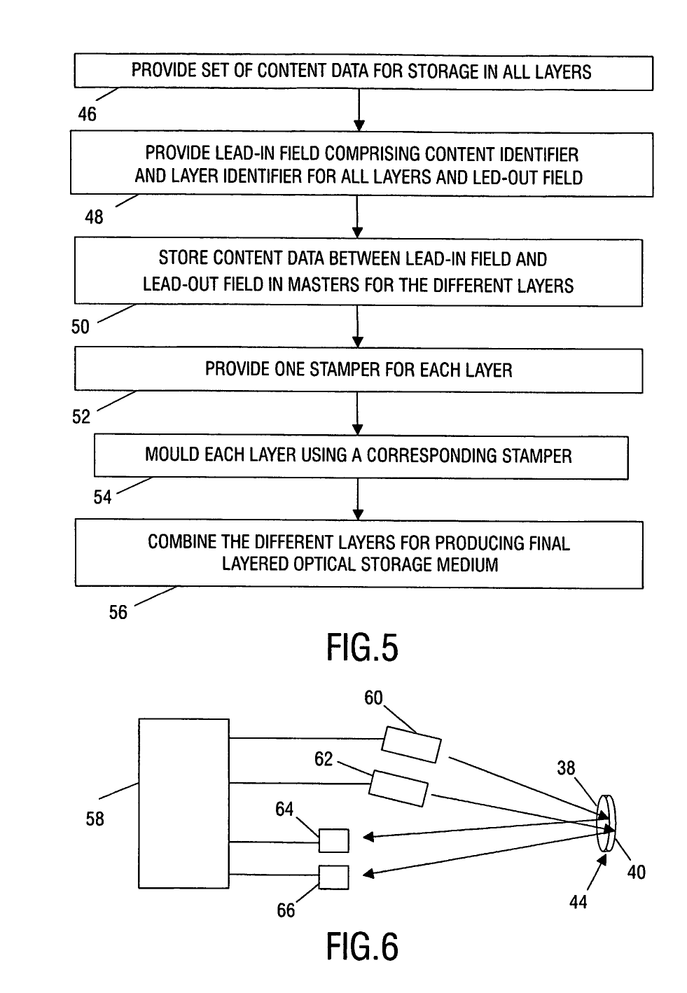

FIG. 5 shows a flow chart of a method of forming the layered storage medium according to one embodiment of the present invention,

FIG. 6 schematically illustrates a device for indicating correctness of data according to one embodiment of the present invention, and

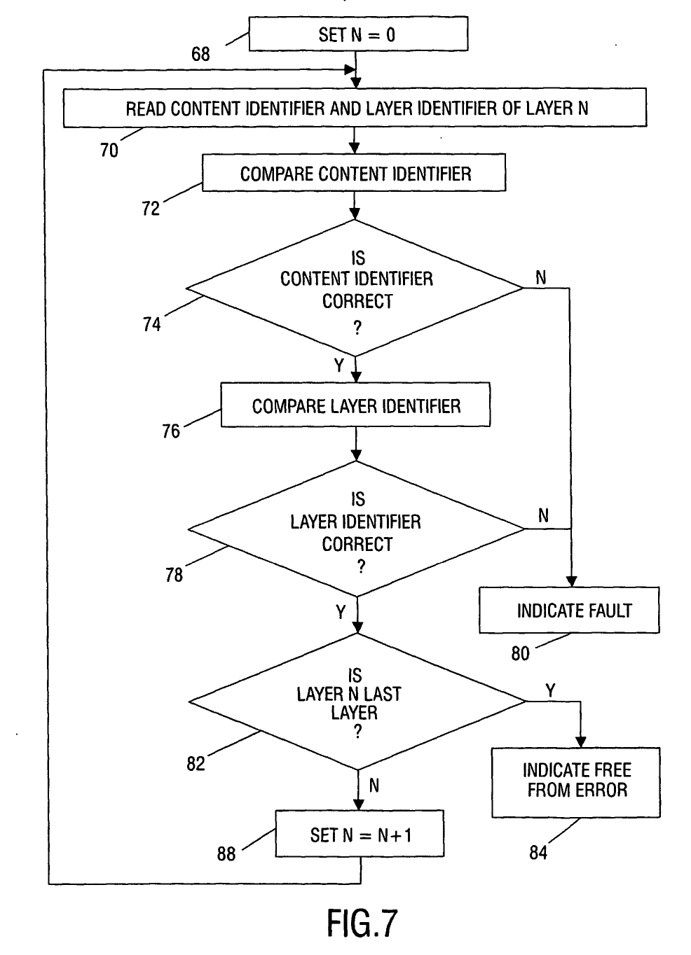

FIG. 7 shows a flow chart of a method of indicating correctness of data according to one embodiment of the present invention.

The invention will now be described in relation to a layered storage medium in the form of an optical disc having two different layers. It should be realized that the medium could have more layers than this. In one of the standards under development, the so-called Blu-ray Disc standard, there is a possibility to have eight different layers. In this description of the invention the number is limited to two for easier explanation of the inventive concept.

Starting with reference to FIG. 1, which schematically illustrates a set up for providing two master discs, the set up includes a first control unit 10, which communicates with a first and a second laser 12 and 16. Each laser 12, 16 emits light under the control of the control unit 10 for storing data on a corresponding master disc 14 and 18. The first control unit 10 includes a set of content data which has a common origin. The set can be a movie, a music album or perhaps a combination of both or other combinations of content data, i.e. is intended to be packaged and sold as one entity. The set is to be stored on two layers of the finalized layered storage medium. The data for each layer is stored in the first control unit 10 according to a pre-defined format, which will be described later with reference to FIG. 2. Alternatively the first control unit 10 can provide the format in which the content data is to be provided on the finalized disc. The first control unit 10 also includes control mechanisms for controlling the lasers to emit light in order to store information on the master discs 14 and 18. The lasers are then controlled such that the data according to the pre-defined format is stored on the discs 14, 18. A first of the master discs 14 is provided for a first layer L0, while a second of the master discs 18 is provided for a second layer L1. The general technology for providing master discs is well known in the art and can be varied in many ways. However common to these variations is that pits are created in the master, which correspond to the information stored.

The signal format 19 of each layer is shown in FIG. 2. Each layer includes a lead-in area 20 followed by a data area 22 and ended by a lead-out area 24. The data area 22 includes the parts of the set of data that is to be stored in the finalized layer according to the format used for the disc. Lead-in areas, data areas and lead-out areas are all well known within the art, for instance from the SACD standard. The lead-in area does however according to the invention include some special information, for easier identification of the correct arrangement of data in the finalized storage medium. For this reason the lead-in area comprises, at a pre-defined, specific position, identifying data 26, 28, which includes two fields. A first field 26 including a content identifier that is common for and indicative of the whole set of data and a layer identifier 28, which identifies which position the layer is to have in the finalized storage medium. Here these are provided one after the other. This is preferred, but they can just as well be spaced apart as long as their positions are known.

Content data, which content is preferably media content, can as described above be a film, a record album containing a number of songs, a combination of both, but just as well perhaps some text as sub-titles for the film or literature, still images either separately or in combination which is to be stored in the layer. The content is therefore grouped into one set, which is to be packaged and sold as one entity. For this reason the set of content is provided with a number, which can be a content or catalogue number of the film, an ISRC code for a CD or an ISBN number for a book, that is common for the whole content of the set. It is furthermore possible that this number can be different for different versions of a set of media content. A film might for instance be produced for different markets, where some scenes are included in some countries and not in others. Then there is a possibility to provide different sets of content data for these different versions of the same film, where each different set has a different number. The same applies for different music albums, where different mixes of a number of songs can be provided in different sets of content data, each associated with a different content number.

In the embodiment described above, the identifying data was provided in the lead-in area. In for instance BD, the fields are preferably provided in the PIC-band (Permanent Information and Control) provided in the lead-in area, which band otherwise includes information about the capacity of the layer, maximum data rates etc. However, this identifying data does not have to be provided in the lead-in area. It can for instance be provided anywhere in the layer, provided the position is pre-defined, so that the information can be easily and directly read.

Each master disc is therefore provided with a different part of the set of data, but the lead-in area includes the same content identifier, but different layer identifiers. The first master disc therefore receives the content identifier for the specific content followed by a layer identifier indicating layer L0, while the second master receives the same content identifier for the specific content but another layer identifier indicating layer L1.

From each master is then made a stamper, where FIG. 3 shows a stamper 30 made from the second master 18. The stamper 30 is formed after the structure of the master so that the stamper adapts itself after the pits in the master, which can for instance be done through electroplating.

As is shown in FIG. 4 each formed stamper 30 and 32 for each of the layers L0 and L1 is then used in a layer data transferring unit or moulding unit 34 and 36, which moulds the substrates or layers 38 and 40, respectively, which are to be used in the finalized storage medium 44. The layers 38 and 40 are then brought to a combining or bonding unit 42, which combines or bonds together the layers 38 and 40 to form the finalized layered storage medium 44. This is normally done using glue. In the shift from moulding to bonding there is a risk that a wrong layer or substrate is brought into the bonding unit 42. It should here be understood that a simplified production process has been described. It can, and normally does include several further production steps, but the standard storage medium production is well known within the art and need therefore not be further described here. Alternative ways of producing layered storage mediums are also well known within the art.

The method of providing a storage medium according to the invention can therefore be summarized as follows with reference made to FIG. 5, which shows a flow chart of the method of providing data in a layered storage medium according to a preferred embodiment of the present invention. First a set of content data for storage in all layers is provided, step 46. A signal structure for content data is then provided for each layer with a lead-in area comprising a content identifier common for and indicative of the whole content and a layer identifier as well as a lead-out area, step 48. The set of content data is then stored on the masters, where different parts of the content data are stored on different masters, in a data area between the lead-in area and the lead-out area, step 50. Each master having content data belonging to the same set therefore has the same content identifier. Thereafter stampers are provided for each layer based on the masters, step 52. The stampers are then used for moulding the different layers, step 54, whereupon the different layers are combined for producing the final layered optical storage medium, step 56.

In the description made above there was described one set of data, which occupied the whole layered storage medium. When this is done according to the invention it is easy to identify if all layers in the medium are the correct ones, i.e. if they belong to the right set of content data an also if the layers are provided in the correct order. This can furthermore be done without having to playback the set of data, but by directly reading the identifiers in the known positions. It should however be realized that the invention is not limited to providing the same set of data in all of the layers. One set can take up less space, like for instance only two layers in an eight-layer medium or even only one layer. It is thus also possible to provide different sets in all different layers. Each layer can however not include content data from more than one set. The correct combination of sets of data and layers are however easily checked because of the invention. This is of course of advantage when large batches of storage mediums are produced and each batch has to be checked for correctness in order to avoid shipping a faulty product.

As mentioned above the checking of correct production of storage mediums is easily and quickly performed. Consequently a method and device for checking of produced storage medium according to the present invention will now be described with reference being made to FIG. 6 and 7, which schematically show a device for indicating the correctness of data and a flow chart of a method of indicating correctness of data according to one embodiment of the invention.

The device includes a second control unit 58, which is connected to a third and fourth laser 60 and 62 for illuminating different layers 38 and 40 of the storage medium 44. The light reflected from the first layer 38 is received by a first optical receiver 64 and the light from the second layer 40 is received by a second optical receiver 66. The receivers are then connected to the second control unit 58 for processing. The third laser 60 and the first optical receiver 64 then make up a first data reading unit, while the fourth laser 62 and the second optical receiver 66 make up a second data reading unit. The second control unit 58 is here an evaluating unit. The optical receivers here only receive the identifying data of layers of the investigated disc, since the position for this information is known. The functioning of the device will now be described with reference to FIG. 7. The second control unit 58 includes information about what content identifiers and layer identifier combination the storage medium is supposed to have. Here the checking of layers is made sequentially. It should be realized that it could just as well be made in parallel. First the second control unit 58 sets a layer counter n to zero, step 68, and thereafter it makes the third laser 60 emit light for reading the identifying data in the first layer 38, by the first optical receiver 64, which result is then provided to the second control unit 58, step 70. The second control unit 58 then compares the received content identifier with the stored content identifier, step 72. If the content identifier was not correct, step 74, a fault is indicated, step 80, by the second control unit 58. If however the content identifier was correct, step 74, the second control unit 58 goes on to compare the layer identifier, step 76. If the layer identifier was not correct, i.e. did not correspond to the pre-stored identifier, a fault is indicated, step 80. If however the identifier was correct the control unit continues to check the layer counter, step 82. If the layer was the last layer in the structure, an indication is made that the storage medium is error free, step 84. If however the layer investigated was not the last layer, the layer counter is incremented by one, step 88, and the identifying data in the next layer is read, step 70, which in this case is done through reading the identifying data using the fourth laser 62 and the second optical receiver 66.

In this way the finalized optical storage medium is easily and quickly checked for correctness by just reading the identifying information in the known position of each layer without the need for playback of the actual content for assessing correctness.

There are several variations that can be made of the method described above. It is for instance possible to only use one data reading unit, which is made to read all layers. In case one set of content data is provided in all the layers, the control unit does not have to include information about what layers are supposed to have what content and in what layer. It is then enough to sequentially go through the disc layers and indicate a correct combination if all the content identifiers are the same and if the layer identifiers are provided sequentially.

Another possible variation is that correctness does not have to be checked in the finalized product. It is equally as well possible to check the stampers or the layers before bonding. In this case the check might be made only on one stamper or substrate at a time.

As mentioned above, the invention is the subject of many variations, why it is only to be limited by the following claims.

1. A method for providing data in a layered storage medium comprising the steps of:
providing at least one set of content data for storage in at least one layer (38, 40) of the storage medium (44), (step 46),
providing, for each layer, identifying data (26, 28) corresponding to a set of content data, of which at least parts is to be provided in the layer, which identifying data comprises a content identifier (26) that is common for and indicative of that whole set of content data, (step 48), and
storing content data together with corresponding identifying data in each layer (38, 40) of the storage medium (44), such that each layer having content data belonging to the same set has the same content identifier.

2. A method according to claim 1, in which the identifying data also comprises a layer identifier (28) and the step of storing comprises storing content data together with identifying data also identifying the actual layer in each layer of the storage medium.

3. A method according to claim 1, wherein one set of data is provided in at least two layers.

4. A method according to claim 1, wherein the identifying data is provided in a specific position in each layer.

5. A method according to claim 4, wherein the identifying data is stored in a lead-in area (20) of each layer.

6. A method according to claim 4, wherein the identifying data is stored in a PIC-band of each layer.

7. A method according to claim 1, wherein the identifier that is common for and indicative of the whole content is a content or catalogue number.

8. A method according to claim 2, wherein each layer identifier comprises a code that is unique for said layer.

9. Device for providing a layered storage medium having content data, comprising:
at least one layer data transferring unit (34, 36) for providing layer data in different layers of a storage medium, where the data for each layer comprises at least parts of a set of content data and identifying data (26, 28), which identifying data comprises a content identifier (26) that is common for and indicative of that whole set of content data, and
a combining unit (42) for combining the layers into a layered storage medium (44), such that each layer having data belonging to the same set of content data has the same content identifier.

10. Storage medium (44) comprising at least two different layers (38, 40) of layer data, where each layer comprises at least parts of a set of content data and identifying data (26, 28), which identifying data comprises a content identifier (26) that is common for and indicative of that whole set of content data, such that each layer having data belonging to the same set of content data has the same content identifier.

11. Signal (19) for provision of layer data in a layer (38, 40) of a layered storage medium (44) comprising at least parts of a set of content data and identifying data (26, 28), which identifying data comprises a content identifier (26) that is common for and indicative of that whole set of content data, such that each layer having data belonging to the same set of content data receives the same content identifier.

12. A method of indicating correctness of content data stored in or associated with at least two different layers of a layered storage medium comprising the steps of:
reading identifying data (26, 28) from or for at least one layer (38, 40), which identifying data includes a content identifier (26) that is common for and indicative of the whole content of one set of content data, where at least parts of the set is provided in the layer, such that each layer having data belonging to the same set of content data has the same content identifier, (step 70),
comparing content identifiers, (step 72), and
indicating if content identifiers in or for the investigated layers correspond to a correct combination (step 84) or not (step 80).

13. Method according to claim 12, wherein the step of reading identifying data comprises reading identifying data from or for at least two layers.

14. Method according to claim 12, wherein the identifying data also comprises a layer identifier (28) and further comprising the steps of comparing layer identifiers, (step 76) and indicating if layer identifiers in or for the investigated layers correspond to a correct combination (step 84) or not (step 80).

15. Device for indicating correctness of data in or for a layered storage medium (44) having at least two layers (38, 40), where at least one set of content data is stored, and comprising:
at least one data reading unit (60, 62, 64, 66) arranged to read identifying data (26, 28) from or for at least one layer, which comprises a content identifier (26) that is common for and indicative of the whole content of one set of content data, where at least parts of the set is provided in the layer, such that each layer having data belonging to the same set of content data has the same content identifier, and
an evaluating unit (58) arranged to compare content identifiers, and
indicate if content identifiers in or for the investigated layers correspond to a correct combination.
